(19) United States
(12) Patent Application Publication
(10) Pub. No.: US 2006/0235698 A1
(43) Pub. Date: Oct. 19, 2006

(54) APPARATUS FOR CONTROLLING A HOME THEATER SYSTEM BY SPEECH COMMANDS

(76) Inventors: David A. Cane, Cambridge, MA (US); Jonathan F. Freidin, Marblehead, MA (US)

Correspondence Address: LAW OFFICE OF DAVID H. JUDSON, 15950 DALLAS PARKWAY, SUITE 225, DALLAS, TX, 75248, US

(21) Appl. No.: 10/907,720

(22) Filed: Apr. 13, 2005

(51) Int. Cl. G10L 21/00

(52) U.S. Cl. 704/275

(57) ABSTRACT

A “reduced button count” remote control device controls a set of external electronic devices that, collectively, comprise an entertainment system such as a home theater. The remote control device is operable in conjunction with a processor-based subsystem that is programmable to respond to a spoken command phrase for selectively altering an operational state of one or more of the external electronic devices to cause the entertainment system to enter a given activity. The remote control device includes a set of buttons supported within a housing, the set of buttons consisting essentially of a push-to-talk button, a first subset of buttons dedicated to providing up and down volume and channel control, a second subset of buttons dedicated to providing motion control, and a third subset buttons dedicated to providing menu selection control. Preferably, each of the buttons has a fixed, given function irrespective of the particular command phrases or the given system activities. After the push-to-talk button is selected to engage the processor-based subsystem to recognize a spoken command phrase to cause the entertainment system to enter the activity mode, the first subset of buttons is used to provide any required up and down volume and channel control, the second subset of buttons is used to provide any required motion control, and the third subset of buttons is used to provide any required menu selection control.

### TECHNICAL FIELD

This invention relates generally to electronic home theater remote controls and more particularly to apparatus for controlling home theater devices through a combination of speech commands and button actuations.

### DESCRIPTION OF THE RELATED ART

Home theater systems have grown increasingly complex over time, frustrating the ability of users to control them easily. For example, the act of watching a DVD typically requires that a user turn on a display device (TV, flat screen panel, or projector), turn on a DVD player, turn on an audio system, set the audio input to the DVD audio output, and then set the display input to the DVD video output. This requires the use of three remote control devices (sometimes referred to herein as “remotes”) to give five commands, as well as knowledge of how the system has been wired. With the addition of broadcast or cable, a VCR, and video games, the typical user may have at least five remotes, and well over a hundred buttons to deal with. There is also the problem of knowing the right sequence of buttons to press to configure the system for a given activity.

The introduction of universal remotes has not solved the problem. The most common of these devices allow for memorized sequences of commands to configure the set of devices in the home theater system. These fail to provide user satisfaction, in part because the problem of non idempotent control codes for devices means that no sequence of control codes can correctly configure the system independent of its previous state. Moreover, the use of a handheld IR emitter in such devices often cannot provide for reliable operation across multiple devices because of possible aiming problems.

Even after accounting for duplicate buttons across devices, a typical home theater universal remote has at least 50 buttons, provided as some combination of “hard” (those with tactile feedback) buttons as well as a touch screen display to cram even more in a limited space. These arrangements provide for a difficult to use control, particularly one that is used primarily in the dark, because the frequently used buttons are hidden in a collection of less important buttons.

There have been efforts in the prior art to provide universal remote devices that are easier to use and/or that may have a smaller number of buttons. Thus, for example, it is well known to use voice recognition technologies in association with a remote control device to enable a user to speak certain commands in lieu of having to identify and select control buttons. Representative prior art patents of this type include U.S. Pat. No. 6,553,345 to Kuhn et al and U.S. Pat. No. 6,747,566 to Hou.

More typically, and to reduce the number of control buttons, a universal remote may include one or more buttons that are “programmable,” i.e., whose function is otherwise changeable or assignable depending on a given mode into which the device is placed. This type of device may also include a display and a control mechanism (such as a scroll wheel or the like) by which the user identifies a given mode of operation and that, once selected, defines the particular function of a given button on the device. Several commercial devices, such as the Sony TP-504 universal remote, fall into this category. Devices such as these with mode-programmable buttons are no easier to use than other remotes, as they still require the user to determine the proper mode manually and remember or learn the appropriate association between a given mode and a given button's assigned or programmed function.

Also, recently controls have been introduced (see, e.g., U.S. Pat. No. 6,784,805 to Harris et al.) that allow for shadow state tracking of devices. This patent describes a state-based remote control system that controls operation of a plurality of electronic devices as a coordinated system based on an overall task (e.g., watch television). The electronic system described in this patent automatically determines the actions required to achieve the desired task based upon the current state of the external electronic devices.

### BRIEF SUMMARY OF THE INVENTION

The present invention substantially departs from the prior art to provide a remote control that makes it easy for a user to provide reliable control of complex functions as well as making the simplest functions easy to operate, preferably through a dedicated set of buttons, so few in number that they can be readily operated by feel, even in a darkened environment. In contrast to the prior art, the present invention provides a remote control device that implements a human factors approach to provide an easy to use mix of buttons for those commands best suited to their use, in conjunction with associated speech-based control for those commands best suited to their use, to provide an easy to use control for home theater systems.

In accordance with the present invention, apparatus is provided to control a system that is a collection of devices, such as a DVD player, DVR, plasma screen, audio amplifier, radio receiver, TV tuner, or the like, which collection of devices work in concert to provide a multi-function home theater capability.

Such a system is usually operated in one of many possible major modes. For example, a mode might be to watch broadcast television, or watch a DVD, or a video tape. Typically, a user uses a speech command to establish the mode he or she wishes, for example, watch a DVD, and then uses button commands (selected from a constrained set of buttons) to provide additional controls for such items as play, pause, fast forward, and volume.

In one embodiment, the apparatus comprises a set of components. There is a handheld device containing a microphone, a constrained or limited set of buttons, and a transmission circuit for conveying user command to a control component. The control component preferably comprises a microprocessor and associated memory, together with input/output (I/O) components to interpret the speech and button press information, thereby to compute a set of one or more device codes needed to carry out user commands. The apparatus preferably also includes at least one or more infrared devices (such as an infrared emitter) positioned so as to provide highly reliable control of the home theater devices.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a block diagram of an embodiment of the invention controlling a typical home theater system.

FIG. 2 is a block diagram of representative components of the present invention in one embodiment.

FIG. 3 illustrates a set of functions performed by the control apparatus.

FIG. 4 is a representative algorithm that may be used to implement certain aspects of the invention;

FIG. 5 is a table that maps station names to channel numbers in an exemplary embodiment;

FIG. 6 is a table that maps speech and button commands to device commands in an exemplary embodiment; and

FIG. 7 is a table that illustrates how home theater devices may be configured for a possible set of major activities in an exemplary embodiment.

### DETAILED DESCRIPTION OF THE INVENTION

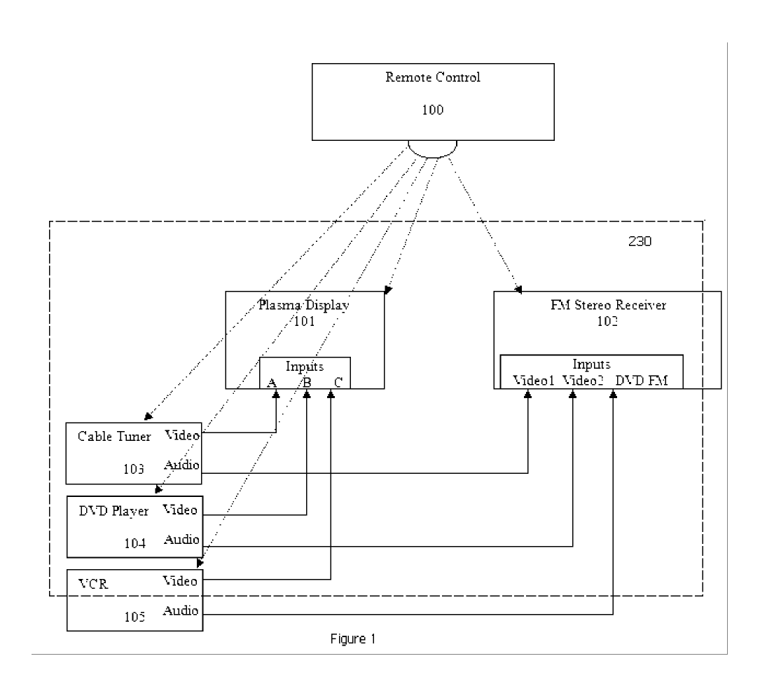

Referring to FIG. 1, in an illustrative embodiment a remote control device 100 provides control through transmitted control sequences to each of the devices 101-105 that collectively form a home theater 110. It is to be understood that the home theater is not limited to the number or types of devices shown. Thus, a representative home theater system may include one or more of the following electronic devices: a television, a receiver, a digital recorder, a DVD player, a VCR, a CD player, an amplifier, a computer, a multimedia controller, an equalizer, a tape player, a cable device, a satellite receiver, lighting, HVAC, a window shade, furniture controls, and other such devices.

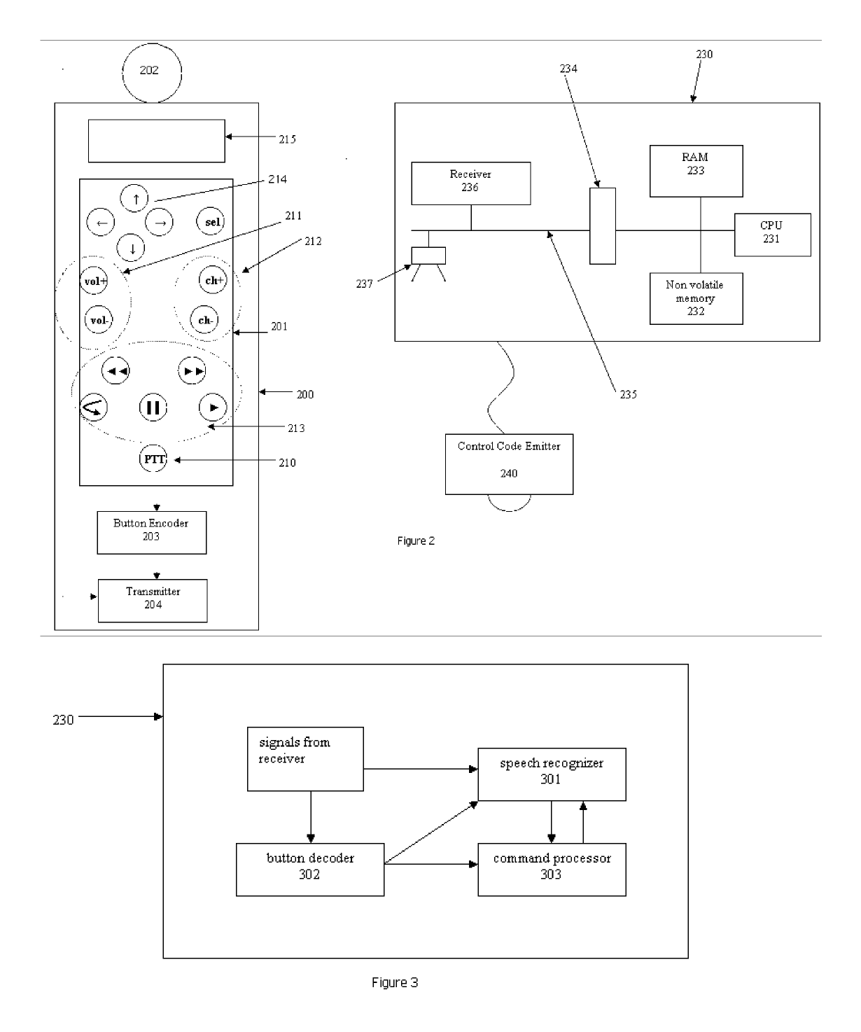

Referring to FIG. 2, a representative control system of the present invention typically comprises a set of components, namely, a handheld “remote” 200, a control device 230, and a control code emitter 240.

Handheld 200 provides the user with means to provide speech and button commands to the apparatus. Microphone 202 allows for entry of speech commands. As will be seen, preferably speech is used for entry of high level commands. Keypad 201 provides for button actuated commands and there is only a limited set of buttons, as will be described. The buttons are illustrated as “hard” (i.e., mechanical in the sense of providing tactile feedback or response), but this is not a requirement. Other types of input controls can be used instead of a button or buttons. These include a jog (dial) switch, a touch sensitive screen (with a set of electronic or “simulated” buttons), or the like. Thus, more generally the handheld unit may be deemed to be a communications device that includes a set of manual input devices, such as the set of buttons. The speech output of the microphone 202 is sent via transmitter 204 to control device 230. A specific button press on keypad 201 is encoded by encoder 203 and sent to transmitter 204, which sends the button signal to control device 230. Push to talk (PTT) button 210 preferably controls the encoder 203 to generate one signal when the button is depressed and another when the button is released. While the PTT function is shown as implemented with a mechanical button 210, this function may also be implemented under speech control, in an alternative embodiment. Thus, as used herein, a push-to-talk control mechanism is activated manually (e.g., by the user depressing a switch) or by a voice-activated push-to-talk function (using, for example, noise cancellation and signal threshold detection). Thus, as mechanical depression of a button is not required for activation, more generally this functionality may be deemed an “activate to talk control mechanism” or the like.

As mentioned above, preferably the inventive handheld device has only a limited set of buttons, which provides significant advantages in ease of use especially when the device is used in a darkened environment. Despite the small number of buttons (sometimes referred to herein as a “small button count”), the remote control provides enhanced functionality as compared to the prior art, primarily by virtue of the selective use of speech commands, as will be described in more detail below. In a preferred embodiment, the handheld keypad (whether hard or electronically-generated) consists essentially of the PTT button 210, volume control buttons 211 (up and down), channel control buttons 212 (up and down), motion control buttons 213 (preferably, play, rewind, fast forward, pause, replay and, optionally, stop), and menu control buttons (preferably, up, down, left, right and select) 214. Other buttons are not required and, indeed, are superfluous given that these buttons are the most commonly used buttons in home theater systems. As will be seen, the selective use of speech commands to place the apparatus in given high level activities (as well as to provide for device control within a given activity) enables the handheld keypad button count to be substantially reduced, as the keypad need only include those buttons (e.g., volume up/down, channel up/down, motion controls, menu selection) that are required to remotely control the given home theater electronic devices in their normal, expected manner. Thus, for example, because channel numbers preferably are enabled through speech, at least 10 number buttons are not required. Likewise, using speech for infrequent (but important) DVD commands (such as “subtitle,” “angle,” “zoom” and the like) saves 6-10 additional buttons for just that device. When this design philosophy is applied across the electronic devices that comprise a typical home theater system, it can be seen the “reduced button count” remote provide only those control buttons that are reasonably necessary and/or desirable.

As will be seen, this particular “small” or reduced button count takes advantage of expected or normal user behavior (and, in particular, a user's decision to choose the convenience of a button over an equivalent speech command) to carefully balance the use of speech and button control in a universal remote control device. This delicate balance is achieved through the inventive handheld device, which provides just the proper number of control buttons together with PTT-based speech control, to produce a remote that, from a human factors standpoint, is optimized for a complex home theater system—one that has the fewest number of useful control buttons yet provides a large number of functions.

One of ordinary skill in the art will appreciate that a “small button count” remote control device (having the PTT control mechanism) and that provides home theater system control using the described human factors approach may include one or a few other buttons or controls without necessarily departing from the present invention.

FIG. 2 also illustrates the preferred placement of the four (4) button clusters (volume, channel, motion and menu) in the device housing 201. Preferably, the housing 201 is formed of any convenient material, such as an injection-molded plastic, that will support or otherwise house the buttons. Any convenient structure to support the buttons on or in the housing (sometimes referred to as “within”) may be used.

In the preferred embodiment, transmitter 204 is a UHF FM transmitter, and encoder 204 is a DTMF encoder. As an alternative embodiment, any form of wireless transmitter, including both RF and infrared methods, could be used for transmitter 203. Alternative embodiments might also employ other button encoding methods, including pulse code modulation.

Control device 230 is preferably a self-contained computer comprising CPU 231, RAM 233, non volatile memory 232, and I/O controller 234 which creates I/O bus 235 to which are attached receiver 236, loudspeaker 237, and control code emitter 240. Loudspeaker may be omitted if the device is integrated with a home theater sound system. Receiver 236 receives the user commands from handheld 200. Control device 230 may be composed of any number of well-known components, or it may be provided in the form of, as an adjunct to, or as part of, an existing device such as a personal computer, PDA, DVR, cable tuner, home entertainment server, a media center, or the like. Indeed, how and where the control device (or any particular control device function) is implemented is not a limitation of the present invention.

In an illustrative embodiment, CPU 231 executes control algorithms that implement the capability of the invention. RAM 233 provides storage for these algorithms (in the form of software code) and non-volatile RAM 232 provides storage for the program defining the algorithms as well as tables that guide the execution of the algorithms according to the specific configuration of home theater 110. Non-volatile RAM 232 may comprise any one or more of a wide variety of technologies, including but not limited to flash ROM, EAROM, or magnetic disk.

Speaker 237 is used to provide the user with feedback about the success of the speech recognition algorithms, the correctness of the issued commands, and guidance for adjusting the home theater. As an alternative embodiment, handheld 201 may contain display 215 to provide the user with these types of feedback. In this embodiment, transmitter 204 and receiver 236 are implemented as transceivers to allow control device 230 to determine what appears on display 215.

Control code emitter 240 issues control codes to the devices that make up home theater 110. These are most commonly coded infrared signals, but may also include RF signaling methods, or even directly wired signaling methods.

In an illustrative embodiment, control device 230 is located in a separate package from remote 200. This separation facilitates providing a highly capable speech recognizer system that can receive electrical power from the AC line, while remote 200, a handheld device, is necessarily operated on battery power. The more capable speech recognizers require more powerful CPUs to run on, which limit the effective battery life if powered from batteries. Alternate embodiments, however, could choose to package control device 230 in the same case as remote 201.

Control code emitter 240 preferably is also housed in a separate package, so that it can be placed close to the devices of home theater 110. Because a single user command may issue a number of control codes to different devices it is desirable that all such control codes be received to ensure highly reliable control. It is to be understood, however, that variations in the way the major components of the invention are packaged do not affect the scope and spirit of the invention.

FIG. 3 illustrates major logical functions executed on control device 230 in a given embodiment. In particular, signals from receiver 236 are sent to decoder 302 and speech recognizer 301, each of which converts the signals to user commands that are sent to command processor 303.

When a user wishes to give a speech command, he or she first presses and holds PTT (push-to-talk) button 210, speaks the command, and releases button 210. Encoder 203 preferably generates one command for the button press and a second command for the button release. Preferably, speech recognizer 301 and command processor 303 each receive the PTT button press command. Speech recognizer 301 uses this to enable a speech recognition function. Command processor 303 issues a mute code to the audio system through control code emitter 240. Such audio system muting greatly improves the recognition quality and, in particular, by suppressing background noise while the user is speaking. Thus, preferably the speech recognizer is enabled only while the user is holding PTT button 210, which prevents the system from responding to false commands that might arise as part of the program material to which the user is listening. When the user releases PTT button 210, preferably a disable mute code is sent to the audio system, and the speech recognizer is disabled.

Speech recognizer 301 can be any one of numerous commercial or public domain products or code, or variants thereof. Representative recognizer software include, without limitation, CMU Sphinx Group recognition engine, Sphinx 2, Sphinx 3, Sphinx 4, and the acoustic model trainer, SphinxTrain. A representative commercial product is the VoCon 3200 recognizer from ScanSoft. Speech recognition is a well established technology, and the details of it are beyond the scope of this description.

User operation of the home theater system typically involves three basic types of commands: configure commands, device commands, and resynchronization commands. This is not a limitation of the invention, however. Configure commands involve configuring the system for the particular type of operation the user desires, such as watching TV, watching a DVD, listening to FM radio, or the like. The selected operation type is sometimes referred to herein as a “current activity.” Configuring the home theater for the current activity typically requires turning on the power to the required devices, as well as set up of selectors for the audio and display devices. As shown in the example home theater 110, receiver 112 has a four input audio selector, which allows the source to the amplifier and speakers to be any one of three external inputs, in this example labeled as video1, video2, and dvd, as well as an internal inputs for FM radio. Similarly, plasma display 111 includes a three input switch that is connected to cable tuner 113, DVD player 114 and VCR 115. Additional control functions, such as turning down the lights in the room or closing window shades, may also be part of the configuration for the current activity as has been previously described.

As used herein, “device commands” involve sending one or more control codes to a single device of the home theater 110. The particular device selected preferably is a function of both the current mode and the user command. For example, when watching a DVD, the user command “play” should be sent to the DVD player, whereas the command “louder” would be sent to the audio device, the receiver in the current example.

As used herein, “resynchronization commands” allow a user to get all (or a given subset) of the devices in the home theater system in the same state that command processor 303 has tracked them to be.

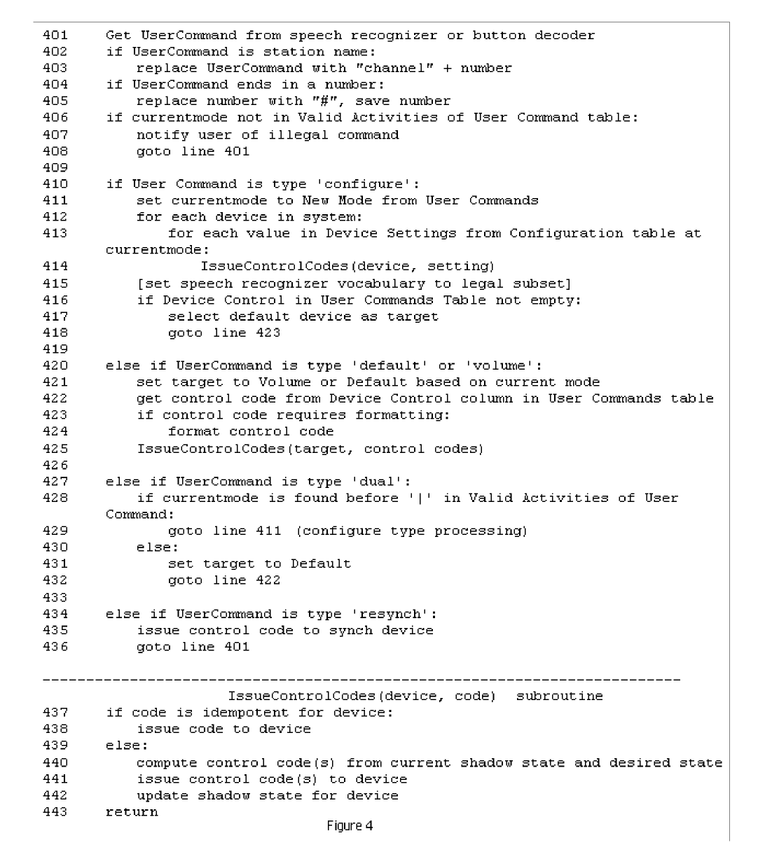

Referring now to FIG. 4, an illustrative operation of a main control algorithm for the invention is described. As noted above, this algorithm (all rights reserved for copyright purposes) may be implemented in software (e.g., as executable code derived from a set of program instructions) executable in a given processor.

Lines 401-436 run as an endless loop processing user commands that are sent from handheld 200. Thus, the algorithm may be considered a state machine having a number of control states, as are now described in more detail.

Lines 402-403 convert a spoken station name to the equivalent channel number, e.g., by looking up the station name in a Stations table 500, an example of which is provided in FIG. 5. Thus, a user may give a spoken command such as “CNN Headline News” without having to know the channel number. A by-product of this functionality is that the remote need not include numeric control buttons, which can increase button count yet substantially impair ease of use.

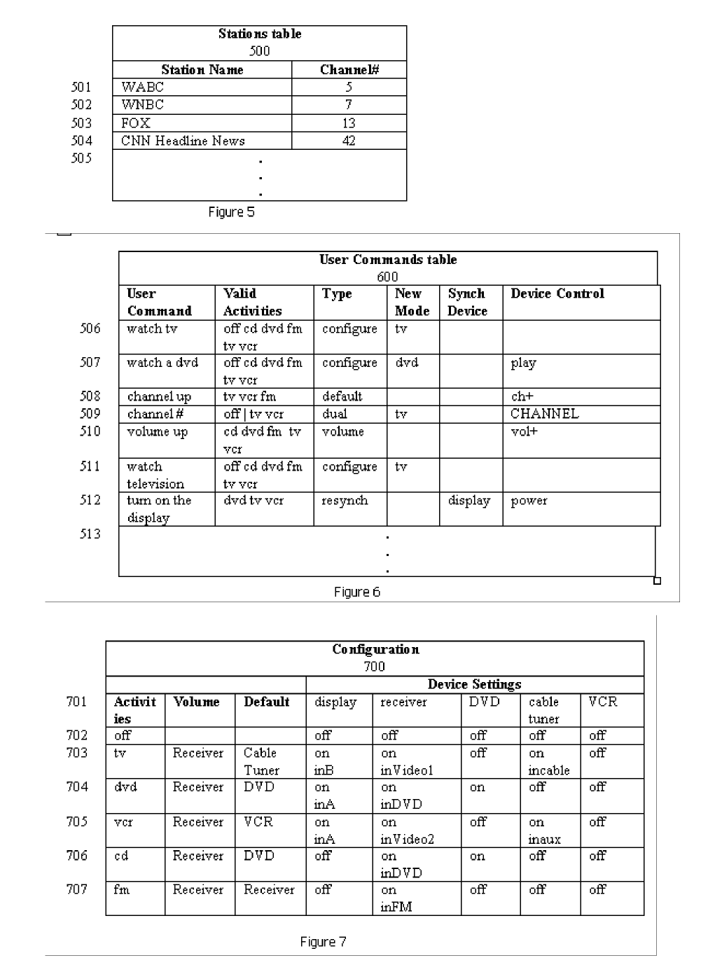

Lines 404-405 function to strip the number from the command and replace it with the symbol “#” before further processing. Such commands as “channel” for TV are spoken as “Channel thirty three” and output from speech recognizer 301 as the string “Channel 33”. This processing facilitates support for the use of a User Commands table 600, such as illustrated in FIG. 6 and described in the next paragraph.

Lines 406-408 test whether or not the user command is valid for the current activity and notify the user of the result of the test. Preferably, this is accomplished by looking up the User Command in the User Commands table 600 for a match in the column labeled “User Command” and checking to see if the current activity is one of the ones listed in the “Valid Activities” column of the table.

The motivation behind this test is to alert the user to an error he or she may have made in issuing a command. For example, if the user was watching a DVD and said “channel five”, there is something amiss because DVD's do not have channels. In the preferred embodiment, notification is done with audio tones. Thus, for example, one beep may be used to signify a valid command, two beeps an invalid command, and so forth. Alternative embodiments could use different notification methods, including different audio tones, speech synthesis (e.g., to announce the currently selected activity), or visual indications.

Lines 410, 420, 427, and 433 test the type of command as defined by the column labeled “Type” in the User Commands table 600. As an example, if the User Command is “Watch TV”, then line 410 looks up the command in User Commands table and finds the value “configure” in the column labeled “Type,” which causes lines 411-418 to be invoked. The column “New Activity” has a value of “tv”, indicating the mode that user desires to set.

Line 411 updates the currentactivity to the activity requested.

Line 412 uses a Configuration table 700, shown in FIG. 7, to find all of the devices in the system, listed in Configuration table 700 at line 701 under the heading “Device Settings”. Line 413 finds the desired state setting(s) for each of the devices identified.

Line 414 invokes an IssueControlCodes subroutine to actually send the control codes to the devices to set them to the desired state.

Lines 437-443 handle the processing of device control with regard to shadow state tracking. For example, some devices have idempotent control codes “on” and “off” that set them directly to a desired state, whereas other only have a “power” code that cycles between on and off states. This subroutine handles the processing of all commands, for example, converting “on” to “power” if and only if its shadow state for the device is off. This routine also handles the updating of its shadow state to reflect the current device state.

Line 415 updates the legal vocabulary for the speech recognizer. This line may be omitted. Generally, recognition improves with a smaller vocabulary; thus, including this line will improve the recognition accuracy for the legal command subset. However, human factors may dictate that it is better to provide feedback to the user (e.g., that his or her command was illegal), rather than providing an indication that the command could not be recognized.

Lines 416-418 deal with mode commands that require additional device controls beyond setting up the overall power and selector configuration states. For example, the command “Watch a DVD” requires that the “play” control be sent to the DVD player after all devices are powered up and configured. If there are no such additional commands, then the processing for configure commands is complete.

Line 420 tests for user commands that only require sending control code(s) to a single device, rather than configuring the whole system. If the Type is default or volume, then the appropriate device is set and the control code(s) is selected from the Device Control column of User Commands table 600.

Lines 423-424 handle the formatting of codes that require device specific knowledge, rather than the ones that are generic to a class of devices. Different TV tuners, for example, have different mechanisms for dealing with the fact that a channel number may be one to three digits. Some tuners require three digits to be sent, using leading zeros to fill in; some require a prefix code telling how many digits will be sent if more than one; and some require a concluding code indicating that if all digits have been sent, take action. These kinds of formatting are most commonly required for commands that take numeric values.

In the preferred embodiment, the following commands and the devices they apply to are supported with numeric formatting: Channel: TV, VCR, DVR (digital video recorder), Disc (DVD, CD), FM Preset, AM Preset, FM Frequency, AM Frequency

Title: DVD

Chapter: DVD

Track: CD

Alternative embodiments might choose more or fewer commands to support with numeric arguments.

After optional formatting, line 425 invokes the IssueControlCodes() subroutine to send the control codes to the devices. This ends the processing for default and volume commands.

Line 427 checks for a dual type command. This is one that acts as either a configure command or a device command, depending on what mode the home theater system is in. For example, if all devices are off, and the user says “Channel Five”, then it is reasonable to assume that he or she wishes to watch TV, so the apparatus must configure the home theater for watching TV, and then set it to channel 5. But if the TV is already on, then it is only necessary to set it to channel 5. If the DVD is on, then the spoken command is probably a mistake.

Line 428 tests the current activity against the Valid Activities of the User Commands table 600. For example, in looking at the line labeled “Channel#,” it can be seen that there are two groups of valid modes separated by a vertical line. If the current activity is in the first group, then this command is treated as a configure type command, otherwise it is treated as a default type command.

Line 434 tests for resynchronization type commands. As noted above, such commands are used to reset the shadow state that tracks cycle activity in devices. There are a variety of ways that the shadow state in the present invention can become un-synchronized with the actual device state. Line 435 sends a control code directly to the device, without invoking the shadow state tracking of subroutine IssueControlCodes(). This allows the device to “catch up” to the shadow state. This completes the processing of the algorithm.

The present invention provides numerous advantages over the prior art, and especially known universal remote control devices. In particular, as has been described the invention describes a unique remote control device that provides reliable control of complex functions as well as making the simplest functions easy to operate, preferably through a dedicated but constrained set of buttons that can be readily operated by feel, even in a darkened environment. In contrast to the prior art, the remote control device implements a human factors approach to provide an easy to use but small number and mix of buttons for those commands best suited to their use, in conjunction with associated speech-based control preferably for device-independent commands. Thus, according to the invention, user input commands are provided through both speech and buttons, with the speech commands being used to select a given (high level, possibly device-independent) activity that, once selected, may be further refined or controlled by the user selecting a given button according to the button's normal and expected function (but not some other, for example, programmed, assigned or perhaps atypical function). Moreover, speech control is also used for many device control functions once a particular high level activity is entered. By selective use of the speech functionality in this manner, the remote need only include the bare minimum of control button clusters (or “subsets”), namely, volume buttons, channel buttons, motion controls, and menu buttons. One of ordinary skill in the art will appreciate that, as noted above, the remote need not (and preferably does not) include separate buttons that describe a set of numerals by which a user may enter a specific numerical selection (as the speech control function may be used for this purpose). In this manner, preferably each button on the remote is not programmable and has one and only one meaning as selected by the speech control functionality. Moreover, a particular button preferably has the same basic functionality (e.g., up, down, left, right, fast, slow, or the like) across multiple activities (as selected by the speech control). Stated another way, once a given activity (or device control function) is selected through the speech control, a given button or button set in the remote can perform only one function (or set of related functions), and this function (or set of related functions) are those which naturally result from the button(s) in question. Thus, for example, if the user speaks a high level command such as “Watch DVD,” the system generates the required control codes (in a state-based manner, or even a state-less manner if desired), with the motion controls on the reduced button count remote then useful to perform only motion-related functionality. As noted above, additional device control functions within a given activity typically are also implemented in speech where possible. The remote control's buttons work only in the manner that a user would expect them to work; they are not programmable and do not perform any other functionality within the context of a given voice-controlled activity or device control function. Each of the limited set of buttons stands on its own in a given speech-controlled activity or device control function. In this manner, speech is used as a substitute for selecting an activity or device control function for a button or set of buttons on the device. The result is a “small button count” remote that provides enhanced functionality as compared to the prior art.

Thus, preferably the universal remote of the present invention does not include any (or more than an immaterial number of) programmable buttons, i.e., a button whose function is dependent on some other (typically manually) operation to assign its meaning. As noted above, however, the use of non-programmable, fixed function buttons in a reduced button count remote actually enhances the ease of use of the overall device because of the carefully balanced way in which the PTT-based speech function is used in conjunction with such button controls. This novel “human factors” approach to universal remote design and implementation provides significant advantages as compared to prior art solutions, which to date have proven wholly unsatisfactory.

It is to be understood that the actual set of legal speech commands typically varies according to the particular configuration of devices. Systems that do not have a DVD present, for example, will not require commands that are unique to DVD players. Even those systems that have DVD players may have slightly differing command sets according to the features of the particular DVD player. It is desired to have just a minimum set of legal commands for the speech recognizer and to not include those commands that are not relevant to the particular system.

According to another feature of the present invention, a set of speech commands (a “command corpus”) (corresponding to the “User Command” column of User Commands table 600) that are available for use by the system preferably are developed in the following preferred manner.

1. For each activity of Configuration table 700, a standard phrase is added to the command corpus to invoke that activity.

2. Each Station Name in Stations table 500 is added to the command corpus.

3. For each device class, (e.g. TV, DVD, etc.) there exists a master list of all command phrases covering all features of that device class. This master list is compared against the control code list for the particular device selected (e.g. Philips TV, model TP27). Those commands on the master list that are present in the device control code list are added to the command corpus. Multiple instances of a single command (e.g. ‘Play’ might have been contributed by both a VCR and a DVD) are collapsed to a single instance.

4. For each device that has cycle tracking, a command phrase to change the cycle for resynchronization commands is added to the command corpus.

The command corpus then is used to build a language model in a conventional way. Note also that the corpus can be formatted and printed to provide custom documentation for the particular configuration.

To improve accuracy of speech recognition, acoustic training may be used. As is well-known, acoustic training can be a time-consuming process if a user has to provide speech samples for every command. According to the present invention, this training process can be optimized by taking the full command corpus, examining the phonemes in each command (including the silence at the beginning and end of the command), and finding a subset of the command list that covers all of the unique n-phone combinations in the full set. Commands with a given number (e.g., 3) or more unique phoneme combinations are preserved. The technique preserves (in the acoustic model) parameters for a given phoneme for the range of contexts embodied in its neighboring phonemes. In particular, this is done by accumulating a partial corpus, sequentially checking for the presence of each n-phone combination in the list then accumulated, and retaining an additional command if and only if it meets the criterion of covering a new n-phone combination.

The method is now illustrated by way of example and, in particular, by considering removal of phrases containing only redundant 3 phoneme sequences. An example command corpus includes the following:
tech-tv (<sil> T EH K T IY V IY <sil>)
w-f-x-t (<sil> D AH B AX L Y UW EH F EH K S T IY <sil>)
disney-west (<sil>D IH Z N IY W EH S T <sil>)
text (<sil> T EH K S T <sil>)

In this example, he phrase “tech-tv” comprises 9 initial 3-phoneme sequences (<si> T EH, T EH K, EH K T, K T IY, T IY V, IY V IY, V IY <sil>), and is retained. “w-f-x-t” comprises 14 additional 3-phoneme sequences (<sil> D AH, D AH B, AH B AX, B AX L, L Y UW, Y UW EH, UW EH F, EH F EH, F EH K, EH K S, K S T, S T IY, T IY <sil>), and is also retained. “disney-west” comprises 9 additional 3-phoneme sequences (<sil> D IH, D IH Z, IH Z N, Z N IY, N IY W, IY W EH, EH S T) and is also retained. The phrase “text,” however, comprises 5 3-phoneme sequences (<sil> T EH, T EH K, present in “tech-tv”, EH K S, K S T, present in w-f-x-t, and S T <sil>, present in “disney-west”). Because all 5 sequences are present in phrases accumulated thus far, the phrase “text” is not retained in the training set.

The process outlined above may be performed in two passes, the command list resulting from the first pass re-processed in reverse order to remove additional commands. Overall, the process of n-phoneme redundancy elimination reduces a typical command set used for acoustic training by 50-80%.

While aspects of the present invention have been described in the context of a method or process, the present invention also relates to apparatus for performing those method or process operations. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the present invention is software written in a given programming language that in executable form runs on a standard hardware platform running an operating system.

While given components of the system have been described separately, one of ordinary skill will appreciate that some of the functions may be combined or shared in given instructions, program sequences, code portions, and the like. In addition, the inventive control system described above may be implemented in whole or in part as original equipment or as an adjunct to existing devices, platforms and systems. Thus, for example, the invention may be practiced with a remote device that exhibits the small button count features together with an existing system, such as a computer or multimedia home entertainment system that includes (whether as existing functionality or otherwise) one or more of the other control system components (e.g., the voice recognizer).

It is also to be understood that the specific embodiment of the invention, which has been described, is merely illustrative and that modifications may be made to the arrangement described without departing from the true spirit and scope of the invention.

Having described our invention, what we now claim is as follows.

What is claimed is:

1. In a control system for controlling a set of electronic devices that together comprise an entertainment system, the control system having a processor-based subsystem that is programmable to respond to a command phrase for selectively altering an operational state of one or more of the electronic devices, the improvement comprising:
a communications device in electronic communication with the subsystem and including a push to talk control mechanism;
a voice recognizer executable by the processor-based subsystem; and
code executable by the processor-based subsystem in response to actuation of the push to talk control mechanism (a) for generating a control code that mutes at least one audio source in the entertainment system, and (b) for enabling the voice recognizer to recognize at least one command phrase while the audio source is muted.

2. In the control system as described in claim 1, wherein the code executable by the processor-based subsystem also provides an indication of whether the command phrase can be acted upon given a presumed state of the one or more electronic devices.

3. In the control system as described in claim 1 wherein the communications device comprises a set of buttons supported within a housing, the set of buttons consisting essentially of up and down volume and channel buttons, motion control buttons, and menu control buttons.

4. In the control system as described in claim 1 further including a control code emitter responsive to the control code for muting the at least one audio source.

5. In the control system as described in claim 4 wherein the control code emitter is distinct from the processor-based subsystem to facilitate control over one or more of the electronic devices irrespective of their relative placement in the entertainment system.

6. In the control system as described in claim 1 wherein the code executable by the processor-based subsystem operates as a state machine to control the set of electronic devices.

7. In the control system as described in claim 1 wherein the code executable by the processor-based subsystem generates at least one control sequence based on a shadow state of one or more of the electronic devices.

8. In the control system as described in claim 1 wherein the code executable by the processor-based subsystem generates one or more control codes to establish a given activity associated with the electronic devices.

9. A remote control device for controlling a set of electronic devices that together comprise an entertainment system, the remote control device operable in conjunction with a processor-based subsystem that is programmable to respond to a spoken command phrase selected from a set of spoken command phrases, the response selectively altering an operational state of one or more of the given electronic devices, comprising:
a housing;
a mechanism supported within the housing that, upon activation, engages the processor-based subsystem to recognize a spoken command phrase in the set of spoken command phrases; and
input means consisting essentially of a set of manual input devices supported within the housing, wherein each device in the set has a given function that is substantially independent of any spoken command and that is not assignable through any other manual operation.

10. The remote control device as described in claim 9 wherein the set of manual input devices consists essentially of a first subset of buttons dedicated to providing a given set of first control actions, a second subset of buttons dedicated to providing a given set of second control actions, and a third subset buttons dedicated to providing a given set of third control actions.

11. The remote control device as described in claim 10 wherein the first subset of buttons consists essentially of volume and channel controls and the given set of first control actions consist essentially of up and down.

12. The remote control device as described in claim 10 wherein the second subset of buttons consists essentially of motion controls and the given set of second control actions consist essentially of play, rewind, fast forward, pause and replay.

13. The remote control device as described in claim 10 wherein the third subset of buttons consists essentially of menu selection controls and the given set of third control actions consist essentially of up, down, left, right and select.

14. The remote control device as described in claim 9 wherein the processor-based subsystem is supported within the housing.

15. The remote control device as described in claim 9 further including a microphone for receiving the spoken command phrase.

16. The remote control device as described in claim 9 wherein the mechanism is a push-to-talk mechanism.

17. A system for controlling a set of electronic devices that together comprise an entertainment system, comprising:
a remote control device comprising a housing, and a set of buttons, the set of buttons consisting essentially of a push-to-talk button, a first subset of non-programmable buttons dedicated to providing up and down volume and channel control, a second subset of non-programmable buttons dedicated to providing motion control, and a third subset non-programmable buttons dedicated to providing menu selection control;
a processor-based subsystem that is programmable to respond to a spoken command phrase for selectively altering an operational state of one or more of the electronic devices;
wherein, after the push-to-talk button of the remote control device is selected to engage the processor-based subsystem to recognize a spoken command phrase, the first subset of buttons is used to provide any required up and down volume and channel control, the second subset of buttons is used to provide any required motion control, and the third subset of buttons is used to provide any required menu selection control.

18. The system as described in claim 17 further including code executable by the processor-based subsystem in response to actuation of the push-to-talk button (a) for generating a control code that mutes at least one audio source in the entertainment system, and (b) for enabling a voice recognizer to recognize at least one spoken command phrase while the audio source is muted.

19. The system as described in claim 17, wherein the code executable by the processor-based subsystem also provides an indication of whether the spoken command phrase can be acted upon given a presumed state of the one or more electronic devices.
